(19) United States
(12) Patent Application Publication
(10) Pub. No.: US 2025/0233496 A1
(43) Pub. Date: Jul. 17, 2025

(54) ELECTRIC AXIAL FLUX MACHINE WITH A ROTOR POSITION SENSOR AND AN ADJUSTING ELEMENT, AND ELECTRIC MACHINE ASSEMBLY

(71) Applicant: Schaeffler Technologies AG & Co. KG, Herzogenaurach (DE)

(72) Inventors: Dirk Reimnitz, Bühl (DE); Ivo AGNER, Bühl (DE)

(73) Assignee: Schaeffler Technologies AG & Co. KG, Herzogenaurach (DE)

(21) Appl. No.: 18/702,862

(22) PCT Filed: Oct. 24, 2022
(86) PCT No.: PCT/DE2022/100780

§ 371 Date: Apr. 19, 2024

(30) Foreign Application Priority Data
Oct. 26, 2021 (DE) 10 2021 127 752.3

(51) Int. Cl. H02K 21/24; H02K 11/21

(52) U.S. Cl. CPC H02K 21/24; H02K 11/21; H02K 2213/09

(57) ABSTRACT

An electric axial flux machine including a stator having at least one stator half, a rotor arranged axially to the at least one stator half and which is rotatably mounted relative to the stator, a rotor shaft which contacts the rotor in a rotationally fixed manner, and a rotor position sensor which has an active sensor section and a passive sensor section. One of the active sensor section or the passive sensor section is directly or indirectly connected to the stator, and the other is fixed to the rotor shaft for conjoint rotation therewith to detect the angular position of the stator relative to the rotor. The axial flux machine additionally has an adjusting element which determines an axial spacing between the active sensor section and the passive sensor section. An electric machine assembly with such an electric axial flux machine is also provided.

### CROSS-REFERENCE TO RELATED APPLICATIONS

This application is the U.S. National Phase of PCT Appln. No. PCT/DE2022/100780, filed Oct. 24, 2022, which claims priority to German Patent Ap-plication No. 10 2021 127 752.3, filed Oct. 26, 2021, the entire disclosures of which are incorporated by reference herein.

### TECHNICAL FIELD

The present disclosure relates to an electric axial flux machine, preferably for driving an electrically drivable motor vehicle, having a stator which has at least one stator half, having a rotor which is arranged in the axial direction with respect to the at least one stator half and which is rotatably mounted relative to the stator, having a rotor shaft which contacts the rotor in a non-rotatable manner, and having at least one rotor position sensor which has an active sensor section and a passive sensor section, wherein one of the active sensor section and the passive sensor section is connected directly or indirectly to the stator, and the other of the active sensor section and the passive sensor section is connected in a non-rotatable manner to the rotor shaft in order to detect an angular position of the stator relative to the rotor.

### BACKGROUND

In electric motors or electric machines, in particular synchronous machines, rotor position sensors are used to constantly detect the rotational position of the rotor relative to that of the stator. More precisely, rotor position sensors detect the current position of the rotor magnets integrated in the rotor, for example permanent magnets, relative to the position of the stator magnets integrated in the stator, for example electromagnets, as a signal. Typically, a rotor position sensor has an active sensor section that is coupled to the stator, in particular to a stator housing or to a component connected to the stator housing, and has a passive sensor section that is coupled in a non-rotatable manner to the rotor shaft, in particular to a component connected to the rotor shaft. In order for the rotor position sensor to provide meaningful information, it is important that the passive sensor section and the active sensor section are very precisely aligned with one another in the axial direction.

This information from the rotor position sensor is important for ensuring that the stator magnets can be energized and controlled correctly. Accordingly, the signals from the rotor position sensors are an important input variable for the power electronics unit of the respective electric motor.

A particular challenge is presented by the exact alignment of the components of the rotor position sensor relative to one another in axial flux machines or axial flux motors as a special type of electric motor. In axial flux machines, the stator and the rotor, which are each designed in the form of flat, usually disc-shaped sub-assemblies, are arranged axially (in relation to an output shaft or rotation axis of the electric motor) next to one another and magnetic forces act between the stator and the rotor in the axial direction. Between the rotor and the stator there are air gaps extending in the radial direction (in relation to an output shaft or rotation axis of the electric motor), the width of which has a major influence on the function and properties of the axial flux machine. The width of the air gaps, i.e., the spacing between the rotor and stator sub-assemblies, should remain unchanged/the same, irrespective of the magnetic forces flowing through them in the axial direction. For this purpose, many components and sub-assemblies of the axial flux machine, in particular in the inner region of the axial flux machine, i.e., in the immediate vicinity of the rotor, are aligned during assembly so that the width of the air gaps and other magnetically relevant distances are optimal and remain as stable as possible.

In the course of this axial component alignment with regard to the magnetically relevant distances, component tolerances have a particularly strong effect on the magnetically less relevant outer regions of the axial flux machine, in particular regions that are not in the direct vicinity of the rotor. In axial flux machines, the rotor position sensors are arranged in such a way that the active and passive sensor sections are spaced apart from one another in the axial direction, i.e., have an axial spacing from one another. In this regard, the active and/or passive sensor section is usually arranged at some distance from the components through which the magnetic forces flow. This means that the active and passive sensor sections of the rotor position sensor are subject to relatively large axial position tolerances. This, in turn, means that the higher component tolerance influence in the outer region of the axial flux machine may have an unfavorable effect on the measuring accuracy of the rotor position sensor.

Accordingly, the rotor position sensor should be as insensitive as possible to axial displacements of the axial flux machine components or be precisely aligned axially by means of a separate axial adjustment process when the sensor is mounted on the axial flux machine. Due to the axially short installation length of the axial flux machine and the large diameter of the axial flux machine relative to the axial installation length, only rotor position sensors with a short axial installation length are usually integrated into the axial flux machine. These installation space requirements often necessitate a sensor operating principle that can usually only cope with small axial displacements between the passive and active sensor sections.

### SUMMARY

Against this background, it is the object of the present disclosure to minimize or eliminate the previously described disadvantages of axial flux machines known from the prior art. In particular, it is the object of the present disclosure to provide an axial flux machine in which the passive and active sensor sections are axially aligned in an exact manner with respect to one another.

This object is achieved in a generic axial flux machine in that the axial flux machine has an adjusting element, in particular an adjusting ring, which determines/controls/dictates the axial spacing between the active sensor section and the passive sensor section, having one or more of the features described herein. The object of the disclosure is also achieved by an electric machine arrangement having one or more of the features described herein.

The axial spacing is the distance between the active and passive sensor sections in the axial direction of the axial flux machine. The axial direction corresponds to the direction in which an output shaft of the axial flux machine extends, the longitudinal axis of which defines the rotation axis of the axial flux machine.

In this regard, the active sensor section measures the position of the passive sensor section relative to itself and uses this to determine an angle. The rotor position sensor thus provides a signal via the active sensor section that indicates the angular position of the stator to the rotor and thus the angular position of the stator magnets relative to the at least one rotor magnet.

The adjusting element can be used to change and adjust/fix the spacing between the active and passive sensor sections in the axial direction. Due to the adjusting element, the active or passive sensor section can be attached at the desired distance from the position of the other sensor section of the respective rotor position sensor resulting from component tolerances and mounting conditions of the axial flux machine. In the axial flux motor according to the invention, it is thus possible to axially align the passive and active sensor sections of the rotor position sensor in an exact manner.

In other words, the present disclosure relates to an electric axial flux machine, preferably for driving an electrically drivable motor vehicle, having a stator and a rotor. A rotor shaft is in rotating contact with the rotor. The rotor is rotatably mounted via at least one bearing point within the electric axial flux machine. Preferably, the stator has at least a first and a second stator half, which are axially spaced apart from the rotor on respectively different axial sides by an air gap. An adjusting element is provided between an active sensor section of a sensor (rotor position sensor) and its axial reference surface of a sensor mount (for example on a stator) and/or between a passive sensor section of the sensor and its axial reference surface of a sensor mount (for example on a rotor). The sensor can be adjusted axially in combination with a form-fitting alignment device and/or anti-rotation means that is effective in the circumferential direction.

Further advantageous embodiments are specified below and in the claims.

In particular, the adjusting element is a component formed separately from the rotor position sensor.

It is advantageous if the stator itself or a component coupled thereto, in particular integrally, has a first holding section which receives the active sensor section, and the rotor shaft, in particular integrally, has a second holding section which receives the passive sensor section, and the adjusting element (in relation to an output shaft or rotation axis of the electric motor) is provided in the axial direction between the active sensor section and the first holding section and/or an adjusting element is provided between the passive sensor section and the second holding section.

In a preferred embodiment of the axial flux machine, the thickness and/or the elasticity of the adjusting element is selected such that the axial spacing between the active sensor section and the passive sensor section is within a predetermined target range.

The thicker and/or the less elastic the adjusting element is, the smaller the spacing between the active and passive sensor sections. The thinner and/or the more elastic the adjusting element is, the greater the spacing between the active and passive sensor sections. This means that the spacing between the active and passive sensor sections can be changed or fixed in a way that is simple to implement. In this context, the spacing between the active and passive sensor sections must be within the predetermined target range in order to ensure reliable operation of the rotor position sensor. This is realized by means of the thickness of the adjusting element.

The first holding section can also be integrally formed with the stator, in particular with a stator housing of the stator, and/or integrally formed with an axial flux machine housing and/or integrally formed with a housing element formed separately from the stator and from the axial flux machine housing, which is connected/coupled to the stator and/or the axial flux machine housing, and the active sensor section (in particular as an independent component) can be formed separately from the first holding section.

Advantageously, therefore, there are various possibilities for mounting the active sensor section within the axial flux machine: on the stator or on the stator housing itself, on the axial flux machine housing or on a housing element that is connected to the stator and/or the axial flux machine housing and is formed separately from these. It is therefore possible to individually attach the active sensor section depending on the structure of the respective axial flux machine. In this regard, the active sensor section is always formed separately from these components of the axial flux machine. This means that the active sensor section can be easily replaced as an independent component independently of the other components of the axial flux machine.

It is further preferred if the second holding section is integrally formed with the rotor shaft, in particular with (an end face of) a shaft shoulder of the rotor shaft, and the second holding section is the passive sensor section or the passive sensor section (as an independent component) is formed separately from the second holding section in the form of a sleeve which is coupled/connected directly and in a non-rotatable manner to the rotor shaft.

For example, the passive sensor section is formed as a plurality of indentations provided on the circumference of an end face of a shaft shoulder of the rotor shaft. In this regard, the indentations are arranged at a predefined angle to the rotor magnets. The active sensor section detects the position of the indentations and can thus determine the angle between the rotor magnets and stator magnets. Alternatively, it is also possible for the passive sensor section to be formed as a separate component from the rotor shaft in the form of a sleeve and be connected to it in a non-rotatable manner.

Further alternatively, it is also possible for the rotor position sensor to detect the position of regions with better electrical or magnetic conductivity and regions with poorer electrical or magnetic conductivity or to detect the position of stronger magnetic regions and weaker magnetic regions.

In particular, the sleeve has a radially extending sleeve section (in relation to an output shaft or rotation axis of the electric motor) and an axially extending sleeve section (in relation to an output shaft or rotation axis of the electric motor), wherein the axially extending sleeve section is in radially abutting contact with a corresponding mating contour on the second holding section.

Advantageously, the radially abutting contact between the passive sensor section and the second holding section or rotor shaft serves to radially align the passive sensor section, which is designed as a sleeve.

In a preferred embodiment, the radially extending sleeve section has indentations on its circumference which are detected by the active sensor section.

An extension extending in the radial direction (in relation to an output shaft or rotation axis of the electric motor) can also be formed on the axially extending sleeve section, which extension engages in a complementarily formed groove on the rotor shaft.

In other words, a form-fitting connection exists between the rotor shaft and the sleeve or passive sensor section. The extension advantageously serves to ensure that the sleeve is also mounted correctly aligned in the circumferential direction (in relation to an output shaft or rotation axis of the electric motor). The extension thus serves as an alignment aid for the passive sensor section. In addition, the extension, in cooperation with the groove on the rotor shaft, prevents the sleeve from rotating in the circumferential direction. This means that the extension also serves as an anti-rotation means.

It is further conceivable that the active sensor section has a projection which extends in the axial direction and which forms an extension at its free end which projects into a mating contour formed complementarily thereto on the first holding section.

This allows the projection on the active sensor section to ensure an exact alignment of the active sensor section in the circumferential direction or in the radial direction relative to the stator magnets integrated in the stator or in the stator halves.

The extension has the advantage that the active sensor section is also mounted correctly aligned in the circumferential direction. In addition, the extension, in cooperation with the corresponding mating contour on the first holding section, prevents the active sensor section from rotating in the circumferential direction.

Furthermore, in the case in which the first holding section is integrally formed with the axial flux machine housing, a first axial flux machine housing section can be connected to the stator, in particular to the stator housing, at a first connection point and a second axial flux machine housing section, which forms the first holding section, can be connected to the first axial flux machine housing section at a second connection point, and an adjusting element can be arranged at the second connection point.

In this case, the axial spacing (spacing in the axial direction) between the active sensor section and the passive sensor section is changed or adjusted via the adjusting element at the second connection point. The installation, removal or replacement of the adjusting element at this second connection point is very easy to implement and can be done more easily than if the adjusting element is arranged between the active sensor section and the first holding section.

However, it is of course also conceivable that, in addition to the adjusting element at the second connection point, an adjusting element is arranged between the active sensor section and the first holding section.

In a further embodiment, in the case in which the first holding section is integrally formed with the stator, in particular with the stator housing, a first axial flux machine housing section is connected to the stator, in particular to the stator housing, at a first connection point and a second axial flux machine housing section is connected to the first axial flux machine housing section at a second connection point, and the adjusting element is arranged at the first connection point.

In this case, the axial spacing (spacing in the axial direction) between the active sensor section and the passive sensor section is changed or adjusted via the adjusting element at the first connection point. The installation, removal or replacement of the adjusting element at this first connection point is very easy to implement and can be done more easily than if the adjusting element is arranged between the active sensor section and the first holding section.

However, it is of course also conceivable that, in addition to the adjusting element at the first connection point, an adjusting element is arranged between the active sensor section and the first holding section.

Even if one rotor position sensor is usually used per axial flux machine, two or more rotor position sensors can of course also be used per axial flux machine.

It is also advantageous if the active sensor section is connected with cables, electrical contacts and/or other power and signal transmission elements.

The active sensor section can, on the one hand, be supplied with energy via these electrical connections and can, on the other hand, also transmit the signals to a process unit (or axial flux machine control module) that is coupled to the axial flux machine, in particular to the active sensor section.

For this purpose, it is desirable if the transition point at which the cables, the electrical contacts and/or the other power and signal transmission elements are passed through the stator, in particular the stator housing, or through the housing element, is provided with a seal.

This seal prevents the undesired ingress of fluid into the axial flux machine at the transition point.

Furthermore, the disclosure relates to an electric machine arrangement having a power electronics unit and/or a high-voltage battery/energy storage device, which has the electric axial flux machine described above. The electric machine arrangement has all the advantages of the electric axial flux machine according to the disclosure.

A drive train with such an electric machine arrangement and a motor vehicle with such a drive train are also proposed.

### BRIEF DESCRIPTION OF THE DRAWINGS

The disclosure will now be explained in more detail below with reference to figures, in which context various embodiments are also described.

In the figures:

FIG. 1 shows a schematic representation of an electric axial flux machine in an I arrangement in an axial section, with a rotor position sensor, wherein the first holding section is provided on the stator housing and the passive sensor section is integrally formed with the rotor shaft;

FIG. 2 shows a schematic representation of an electric axial flux machine in an I arrangement in an axial section, with one rotor position sensor per stator half in different arrangements of active and passive sensor sections; and

FIG. 3 shows a schematic representation of an electric axial flux machine in an I arrangement in an axial section, with one rotor position sensor per stator half, wherein one adjusting element each is provided at a first connection point and at a second connection point.

### DETAILED DESCRIPTION

The figures are merely schematic in nature and serve solely for understanding the disclosure. In particular, it should be noted that the figures and in particular the size relationships shown are only schematic in nature. Identical elements are provided with the same reference symbols. The different features of the various embodiments can also be freely combined with one another.

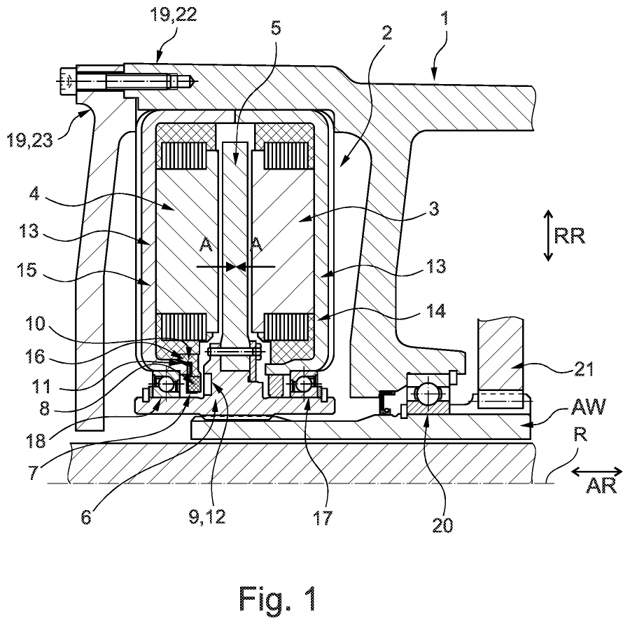

In FIGS. 1 to 3 described below, an output shaft AW of an electric axial flux machine 1 defines the axial direction (see arrow AR) and the radial direction (see arrow RR). The output shaft AW defines the rotation axis R of the axial flux machine 1 with its longitudinal axis, which runs in the axial direction.

FIG. 1 shows an electric axial flux machine 1 having a stator 2, which has a first stator half 3 and a second stator half 4, each with at least one stator magnet (for example an electromagnet). Furthermore, the electric axial flux machine 1 has a rotor 5 arranged between the stator halves 3, 4, which has at least one rotor magnet (for example a permanent magnet) and is rotatably mounted relative to the stator 2, as well as a rotor shaft 6 which contacts the rotor 5 in a non-rotatable manner and at least one rotor position sensor 7. The rotor shaft 6 is connected to an outer toothing of the output shaft AW via an internal toothing. The rotor position sensor 7 is arranged here on the second stator half 4. In this regard, the rotor position sensor 7 is arranged radially within the second stator half 4. The rotor position sensor 7 has an active sensor section 8, which is connected directly or indirectly to the stator 2, and a passive sensor section 9, which is connected in a non-rotatable manner to the rotor shaft 6, in particular is integrally formed therewith. An adjusting element 10 controls/determines the axial spacing between the active sensor section 8 and the passive sensor section 9.

A magnetic field is generated between the stator magnets and the at least one rotor magnet. This magnetic field causes the rotor 5 to rotate relative to the stator 2. The rotor shaft 6 then rotates with the rotor 5 and the toothing of the rotor shaft 6 rotates the output shaft AW, which rotates about its longitudinal axis. A magnetic force acts in the axial direction between the at least one rotor magnet of the rotor 5 and the stator magnets of the stator 2 due to the magnetic field. The magnetic force acts from the stator magnets inwards towards at least one rotor magnet in each case (see arrows A).

The active sensor section 8, which is connected to the stator 2 in a non-rotatable manner, detects the position of the passive sensor section 9, which is connected to the rotor 5 in a non-rotatable manner. Thus, the active sensor section 8 of the rotor position sensor 7 detects an angular position of the stator magnets relative to the rotor magnets.

The active sensor section 8 is provided here as a component formed separately from the stator 2. The active sensor section 8 is directly connected to the stator 2 via a first holding section 11, which corresponds to a region of the stator 2. The active sensor section 8 has electrical or electronic components and is connected to an axial flux machine control module (process unit) via cables (not shown). The active sensor section is controlled via this control module and the active sensor section forwards the signals it generates (angular positions) thereto.

The passive sensor section 9 is integrally formed with the rotor shaft 6. Thus, the passive sensor section 9 is identical to a second holding section 12. More precisely, the passive sensor section 9 is provided in the form of indentations that are recessed in the axial direction starting from the end face of the shaft shoulder of the rotor shaft 6.

If the stator magnets are now energized, they generate a magnetic field. This magnetic field and the resulting magnetic forces attract or repel the rotor magnets. This sets the rotor 5 in a rotary motion. The rotor shaft 6 rotates together with the rotor 5. The active sensor section 8 now detects the position of the passive sensor section 9, which changes with the rotary motion of the rotor shaft 6, and uses this to determine the angular position of the stator magnets in relation to the rotor magnets.

In the axial direction, an adjusting element 10, in particular an adjusting ring, is provided between the active sensor section 8 and the first holding section 11. This adjusting element 10 is used to control the axial spacing (spacing in the axial direction) between the active sensor section 8 and the passive sensor section 9. Thus, the adjusting element 10 can be used to ensure reliable operation of the rotor position sensor 7. The thickness of the adjusting element 10 can be used to precisely and reliably change and fix or control the installation position of the active sensor section 8 relative to the stator 2.

Here, the first holding section 11 is a component of a stator housing 13, which receives the stator 2. The stator housing 13, in turn, has two half shells, a first half shell 14 and a second half shell 15. The first half shell 14 surrounds or encloses the first stator half 3 on the sides of the first stator half 3 that do not face the rotor 5, and thus defines the outer edge or outer side of the first stator half 3. The second half shell 15 surrounds or encloses the second stator half 4 on the sides of the second stator half 4 that do not face the rotor 5, and thus defines the outer edge or outer side of the second stator half 4. The first holding section 11 is integrally formed on the second half shell 15.

The active sensor section 8 has a projection 16 which extends in the axial direction and which has an extension at its free end which projects into a mating contour formed complementarily thereto on the first holding section 11. The thickness of the adjusting element 10 determines how far the extension is inserted into the mating contour on the first holding section 11 when the active sensor section 8 is mounted on the first holding section 11 (on the stator 2). This extension thus provides an alignment aid as well as a secure and constant arrangement in the radial direction or in the circumferential direction of the active sensor section 8 on the first holding section 11.

The first half shell 14 is connected to the rotor shaft 6 via a first bearing 17 and the second half shell 15 is connected to the rotor shaft 6 via a second bearing 18. The first and second bearings 17, 18 are each designed here as single-row angular contact ball bearings. The bearings 17, 18 support the rotor 5 both axially and radially via the rotor shaft 6 on the two stator halves 3 and 4. The first bearing 17 thus connects the first stator half 3 to the rotor shaft 6 and the second bearing 18 connects the second stator half 4 to the rotor shaft 6. More precisely, the first bearing 17 connects the first half shell 14 to the rotor shaft 6 and the second bearing 18 connects the second half shell 15 to the rotor shaft 6. The active sensor section 8 is arranged in the axial direction between the second bearing 18 and the passive sensor section 9 or the end face of the shaft shoulder of the rotor shaft 6.

Furthermore, the electric axial flux machine 1 has an axial flux machine housing 19, to which the stator 2 is connected in a non-rotatable manner. In addition, the axial flux machine housing 19 supports the output shaft AW via a bearing 20 (single-row ball bearing). Furthermore, the output shaft AW meshes with a gear wheel of a gear stage 21 outside the axial flux machine housing 19 via a further external toothing.

The axial flux machine housing 19 has a first axial flux machine housing section 22 and a second axial flux machine housing section 23.

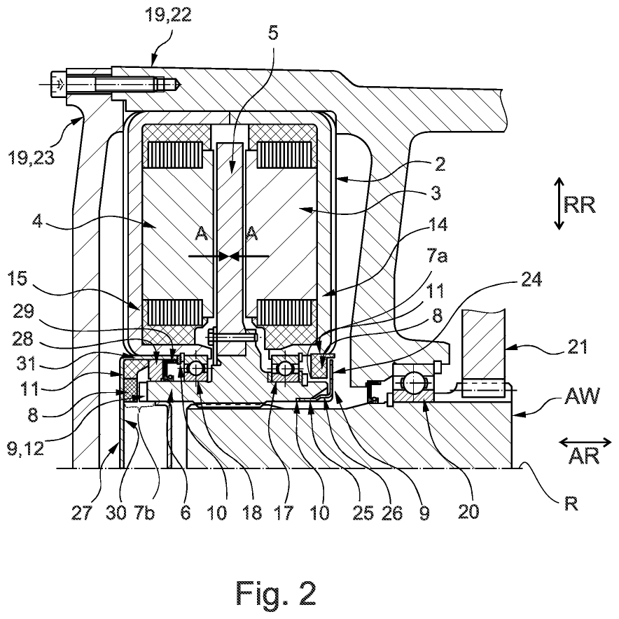

FIG. 2 shows a schematic representation of the electric axial flux machine 1 in an I arrangement in an axial section, with one rotor position sensor 7 per stator half 3, 4. However, it should be noted that FIG. 2 shows one rotor position sensor 7 each per stator half in order to show as many design variants as possible in FIG. 2. In general, one rotor position sensor 7 per axial flux machine 1 is sufficient and there is no reason to install a second rotor position sensor 7 in most axial flux machines 1. Two rotor position sensors 7 per axial flux machine 1 will therefore only be used in special cases, if at all. It should therefore be mentioned that the two rotor position sensors 7 per axial flux machine 1 are only shown for illustrative reasons and that usually only one of the two rotor position sensors 7 is used. The electric axial flux machine 1 of FIG. 2 essentially corresponds to the electric axial flux machine 1 of FIG. 1 with the following differences:

The electric axial flux machine 1 has a first rotor position sensor 7a, which is coupled to the first stator half 3, or a second rotor position sensor 7b, which is coupled to the second stator half 4.

The first rotor position sensor 7a is described below. The first holding section 11 for the active sensor section 8 of the first rotor position sensor 7a is integrally formed with the first half shell 14. In this regard, the active sensor section 8 is arranged in the axial direction close to the side of the first bearing 17 facing away from the rotor 5. An adjusting element 10 is not provided for the active sensor section 8.

Here, the second holding section 12 is integrally formed with the rotor shaft 6. The passive sensor section 9 is designed in the form of a sleeve 9, which is provided separately from the rotor shaft 6 (as an independent component). The sleeve 9 is connected to the rotor shaft 6 via the second holding section 12. In this regard, the sleeve 9 has a radially extending sleeve section 24 and an axially extending sleeve section 25. The axially extending sleeve section 25 is in radially abutting contact with a corresponding mating contour on the second holding section 12. An extension 26 extending in the radial direction is formed on the axially extending sleeve section 25, which engages in a complementarily formed groove on the rotor shaft 6 extending at an angle to a direction of rotation.

The active sensor section 8 is arranged in the axial direction between the first bearing 17 and the radially extending sleeve section 24. The radially extending sleeve section 24 has recesses or indentations which are detected by the active sensor section 8 in order to be able to determine the angular position of the stator magnets relative to the rotor magnets.

In order to attach the sleeve 9 to the rotor shaft 6, the axially extending sleeve section 25 is pressed into the rotor shaft 6. An adjusting element 10 with a fixed thickness is arranged in the axial direction between the rotor shaft 6 and the axially extending sleeve section 25. The thickness of the adjusting element 10 is selected such that the press-in depth can be varied in a process-reliable manner and can be adapted to the actual position of the active sensor section 8. When the sleeve 9 is mounted on the rotor shaft 6, the sleeve 9 is pressed into the rotor shaft 6 until it meets the adjusting element 10 and the press-fit process is then stopped. Alternatively, a travel-controlled press-fit process without an end stop is also possible in order to place the sleeve 9 in the correct axial position relative to the active sensor section 8. Since the axial installation position of the passive sensor section 9 is therefore adapted to the axial position of the active sensor section 8 for the first rotor position sensor 7a, the active sensor section 8 can be attached directly to the stator 2 or to the first half shell 14 (without taking into account axial correction dimensions or adjusting elements). This means that the axial spacing between the active and passive sensor sections 8, 9 is adjusted via the thickness of the adjusting element 10, which is provided axially between the passive sensor section 9 and the rotor shaft 6.

The second rotor position sensor 7b is described below. This sensor is received in a cover-like housing element 27, which adjoins the end face of the second half shell 15 facing the rotor shaft. The housing element 27 is formed as an additional component separate from the stator housing 13 and the axial flux machine housing 19. Strictly speaking, the housing element 27 receives the active sensor section 8 of the second rotor position sensor 7b as well as a shaft grounding ring 28 and a radial shaft sealing ring 29. These three components are in direct contact with the rotor shaft 6 and/or interact therewith. By pushing or pressing the housing element 27 axially into the second stator half 4, the positions of these three components relative to the rotor shaft 6 can be adjusted/fixed by a single adjustment process.

The housing element 27 has a radially extending housing element section 30 and an axially extending housing element section 31. The active sensor section 8 rests against the radially extending housing element section 30. An adjusting element 10 is arranged in the axial direction between the axially extending housing element section 31 and the second bearing 18. The adjusting element 10 serves as a stop, matched to the position of the rotor shaft 6, for mounting the housing element 27 on the stator 2 or on the second stator half 4.

The end face of the shaft shoulder of the rotor shaft 6, which faces the second stator half 4, serves as the passive sensor section 9. For this purpose, it has indentations that can be detected by the active sensor section 8.

The thickness of the adjusting element 10 determines how far the radially extending housing element section 30 and thus the active sensor section 8 are spaced apart from the passive sensor section 9 in the axial direction. As such, the active sensor section 8 is positioned here at the desired axial spacing relative to the passive sensor section 9 using the adjusting element 10.

The housing element 27 can also be provided with an extension projecting in the radial direction, which engages in a complementary mating contour in the second stator half 4 in order to provide an anti-rotation means and alignment aid.

In the present embodiment according to FIG. 2, the first bearing 17 is provided as a fixed bearing that transmits forces both in the radial direction and in the axial direction between the first stator half 3 and the rotor shaft 6. The second bearing 18 is designed as a floating bearing that only transmits forces in the radial direction, but not in the axial direction, between the second stator half 4 and the rotor shaft 6. Due to the displaceable bearing seat (clearance fit) of the second bearing 18 between the rotor shaft 6 and the second bearing 18, the second bearing 18 can move in the axial direction relative to the rotor shaft 6.

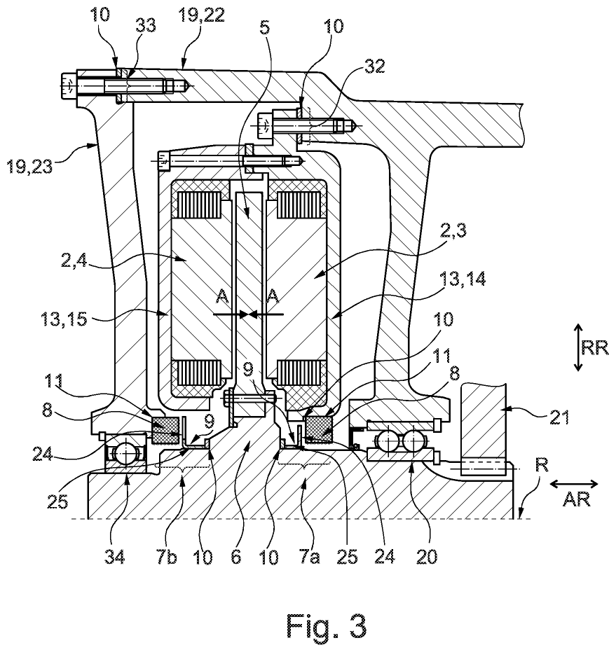

FIG. 3 shows a schematic representation of an electric axial flux machine 1 in an I arrangement in an axial section, with one rotor position sensor 7 per stator half 3, 4. However, it should be noted that FIG. 3 shows one rotor position sensor 7 each per stator half in order to show as many design variants as possible in FIG. 3. In general, one rotor position sensor 7 per axial flux machine 1 is sufficient and there is no reason to install a second rotor position sensor 7 in most axial flux machines 1. Two rotor position sensors 7 per axial flux machine 1 will therefore only be used in special cases, if at all. It should therefore be mentioned that the two rotor position sensors 7 per axial flux machine 1 are only shown for illustrative reasons and that usually only one of the two rotor position sensors 7 is used. The electric axial flux machine 1 of FIG. 3 differs from the electric axial flux machine 1 of FIG. 2 in the following respects:

The first rotor position sensor 7a is first described below. The active sensor section 8 of the first rotor position sensor 7a is directly connected to the first half shell 14 or the first stator half 3 via the first holding section 11, which is integrally formed with the first half shell 14. In the axial direction, an adjusting element 10 is provided between the first holding section 11 and the active sensor section 8. The passive sensor section 9 of the first rotor position sensor 7a is coupled in the form of a sleeve 9 to the second holding section 12, which is integrally formed with the rotor shaft 6. In the axial direction, an adjusting element 10 is provided between the end face of the shaft shoulder of the rotor shaft 6 and the passive sensor section 9. In the axial direction, the passive sensor section 9 is arranged between the rotor shaft 6 and the active sensor section 8.

In the present embodiment, the first and second bearings 17, 18 are omitted. Instead, the stator housing 13 is connected to the first axial flux machine housing section 22 (using a fastening means, in particular a bolt or screw) via a first connection point 32. An adjusting element 10 is also provided at the first connection point 32. In this way, the distance from the active sensor section 8 to the passive sensor section 9 of the first rotor position sensor 7a is fixed by means of the total thickness of the three adjusting elements 10 described above. It should be noted that it is usually sufficient for an exact adjustment of the spacing between the active and passive sensor section (8, 9) if an adjusting element is present on the active sensor section, via which the position of the active sensor section (8) relative to the passive sensor section (9) is fixed, or if an adjusting element is present on the passive sensor section (9), via which the position of the passive sensor section (9) relative to the active sensor section (8) is fixed. If adjusting elements are present on both sensor sections (8, 9), this offers the possibility of compensating for particularly large positional deviations between the two sensor sections (8, 9). In addition or alternatively, adjusting elements on both sensor sections (8, 9) also offer the possibility of separately determining different tolerances and positional influences on different parts or assemblies during an assembly process of the axial flux machine and compensating for them separately with the various adjusting elements.

The second rotor position sensor 7b will now be described. The active sensor section 8 of the second rotor position sensor 7b is directly coupled to the second axial flux machine housing section 23. If the active sensor section 8 is directly coupled to the axial flux machine housing 19, the cable connection between the active sensor section 8 and the control electronics unit, which is also connected to the axial flux machine housing 19, is simplified. In the case where the control electronics unit is connected to the transmission housing, which adjoins the first axial flux machine housing section 22, the active sensor section 8 can in this case be directly connected to the first axial flux machine housing section 22.

The passive sensor section 9 of the second rotor position sensor 7b is coupled in the form of a sleeve 9 to the second holding section 12, which is integrally formed with the rotor shaft 6. In the axial direction, an adjusting element 10 is provided between the end face of the shaft shoulder of the rotor shaft 6 and the passive sensor section 9. In the axial direction, the passive sensor section 9 is arranged between the rotor shaft 6 and the active sensor section 8.

The first and second axial flux machine housing sections 22, 23 are connected to one another via a second connection point 33. An adjusting element 10 is provided at the second connection point 33. In this way, the distance from the active sensor section 8 to the passive sensor section 9 of the second rotor position sensor 7b is fixed by means of the total thickness of the two adjusting elements 10 described above.

The various and differently arranged adjusting elements 10 can be used to precisely align both sensor sections 8, 9 for the first rotor position sensor 7a and for the second rotor position sensor 7b via the adjoining adjusting element 10 itself in each case, or only one sensor section 8, 9 can be aligned axially in a targeted manner relative to the other sensor section 8, 9 of the respective rotor position sensor 7 via the adjoining adjusting element 10. In the present embodiment, the axial spacing between the active and passive sensor sections 8, 9 of the first and/or second rotor position sensor 7a, 7b can additionally or alternatively be adjusted via the adjusting elements 10 at the first and/or second connection points 32, 33.

An alignment aid and anti-rotation means effective in the circumferential direction, as described in connection with the previous embodiments, can be provided for both the first rotor position sensor 7a and the second rotor position sensor 7b.

FIG. 3 does not explicitly show the output shaft AW. The output shaft AW is supported by a further bearing 34 on the second axial flux machine housing section 23.

### LIST OF REFERENCE SYMBOLS

1 Electric axial flux machine
2 Stator
3 First stator half
4 Second stator half
5 Rotor
6 Rotor shaft
7 Rotor position sensor
7a First rotor position sensor
7b Second rotor position sensor
8 Active sensor section
9 Passive sensor section
10 Adjusting element
11 First holding section
12 Second holding section
13 Stator housing
14 First half shell
15 Second half shell
16 Projection
17 First bearing
18 Second bearing
19 Axial flux machine housing
20 Bearing
21 Gear stage
22 First axial flux machine housing section
23 Second axial flux machine housing section
24 Radially extending sleeve section
25 Axially extending sleeve section
26 Extension
27 Housing element
28 Shaft grounding ring
29 Radial shaft sealing ring
30 Radially extending housing element section
31 Axially extending housing element section
32 First connection point
33 Second connection point
34 Bearing
AW Output shaft
R Rotation axis, axial flux machine
Arrow A Effective direction of magnetic force
Arrow AR Axial direction
Arrow RR Radial direction

1. An electric axial flux machine, comprising:
a stator having at least one stator half;
a rotor arranged in axial direction with respect to the at least one stator half and which is rotatably mounted relative to the stator;
a rotor shaft which contacts the rotor in a non-rotatable manner,
at least one rotor position sensor which has an active sensor section and a passive sensor section, wherein one of the active sensor section or and the passive sensor section is connected directly or indirectly to the stator, the other of the active sensor and the passive sensor section is connected in a non-rotatable manner to the rotor shaft in order to detect an angular position of the stator relative to the rotor; and
an adjusting element which determines an axial spacing between the active sensor section and the passive sensor section.

2. The electric axial flux machine according to claim 1, wherein the stator or a component coupled thereto has a first holding section which receives the one of the active sensor section or the passive sensor section, and the rotor or a component coupled thereto has a second holding section which receives the other of the active sensor section or the passive sensor section, and the adjusting element is provided in an axial direction between the one of the active sensor section or the passive sensor section and the first holding section or the adjusting element is provided between the other of the active sensor section or the passive sensor section and the second holding section.

3. The electric axial flux machine according to claim 2, wherein a thickness of the adjusting element is selected such that the axial spacing between the active sensor section and the passive sensor section is within a predetermined target range.

4. The electric axial flux machine according to claim 3, wherein the first holding section is integrally formed with the stator or integrally formed with an axial flux machine housing or integrally formed with a housing element formed separately from the stator and from the axial flux machine housing and connected to the stator or the axial flux machine housing, and the one of the active sensor section and the passive sensor section is formed separately from the first holding section.

5. The electric axial flux machine according to claim 3, wherein the second holding section is integrally formed with the rotor or the rotor shaft, or a component connected in a non-rotatable manner to the rotor or the rotor shaft, and the second holding section is the passive sensor section or the passive sensor section is formed separately from the second holding section, which is connected directly to the rotor or the rotor shaft or is coupled in a non-rotatable manner to the rotor or the rotor shaft.

6. The electric axial flux machine according to claim 5, wherein the passive sensor section formed separately from the second holding section comprises a sleeve which has a radially extending sleeve section and an axially extending sleeve section, and the axially extending sleeve section is in radially abutting contact with a corresponding mating contour on the second holding section.

7. The electric axial flux machine according to claim 6, wherein an extension extending in a radial direction is formed on the axially extending sleeve section, and said extension engages in a complementarily formed groove on the rotor shaft.

8. The electric axial flux machine according to claim 2, wherein the active sensor section has a projection which extends in the axial direction and which forms an extension at a free end thereof which projects into a mating contour formed complementarily thereto on the first holding section.

9. The electric axial flux machine according to claim 4, wherein in the case in which the first holding section is integrally formed with the axial flux machine housing, a first axial flux machine housing section is connected to the stator at a first connection point and a second axial flux machine housing section, which forms the first holding section, is connected to the first axial flux machine housing section at a second connection point, and the adjusting element is arranged at the first connection point or second connection point.

10. An electric machine arrangement comprising, the electric axial flux machine according to claim 1 and at least one of a power electronics unit or a high-voltage battery.

11. An electric axial flux machine, comprising:
a stator;
a rotor arranged in axial direction with respect to the stator and which is rotatably mounted relative to the stator;
a rotor shaft connected non-rotatably to the rotor;
a rotor position sensor which has an active sensor section and a passive sensor section, wherein one of the active sensor section or the passive sensor section is connected directly or indirectly to the stator, and the other of the active sensor and the passive sensor section is non-rotatably connected to the rotor shaft in order to detect an angular position of the stator relative to the rotor; and
an adjusting element having a selected thickness which sets an axial spacing between the active sensor section and the passive sensor section.

12. The electric axial flux machine according to claim 11, wherein the stator or a component coupled thereto has a first holding section which receives the one of the active sensor section or the passive sensor section, and the rotor or a component coupled thereto has a second holding section which receives the other of the active sensor section or the passive sensor section, and the adjusting element is provided in an axial direction between the one of the active sensor section or the passive sensor section and the first holding section or the adjusting element is provided between the other of the active sensor section or the passive sensor section and the second holding section.

13. The electric axial flux machine according to claim 12, wherein the thickness of the adjusting element is selected such that the axial spacing between the active sensor section and the passive sensor section is within a predetermined target range.

14. The electric axial flux machine according to claim 13, wherein the first holding section is integrally formed with the stator or integrally formed with an axial flux machine housing or integrally formed with a housing element formed separately from the stator and from the axial flux machine housing and connected to the stator or the axial flux machine housing, and the one of the active sensor section and the passive sensor section is formed separately from the first holding section.

15. The electric axial flux machine according to claim 13, wherein the second holding section is integrally formed with the rotor or the rotor shaft, or a component connected in a non-rotatable manner to the rotor or the rotor shaft, and the second holding section is the passive sensor section or the passive sensor section is formed separately from the second holding section, which is connected directly to the rotor or the rotor shaft or is coupled in a non-rotatable manner to the rotor or the rotor shaft.

16. The electric axial flux machine according to claim 15, wherein the passive sensor section formed separately from the second holding section comprises a sleeve which has a radially extending sleeve section and an axially extending sleeve section, and the axially extending sleeve section is in radially abutting contact with a corresponding mating contour on the second holding section.

17. The electric axial flux machine according to claim 16, wherein an extension extending in a radial direction is formed on the axially extending sleeve section, and said extension engages in a complementarily formed groove on the rotor shaft.

18. The electric axial flux machine according to claim 12, wherein the active sensor section has a projection which extends in the axial direction and which forms an extension at a free end thereof which projects into a mating contour formed complementarily thereto on the first holding section.

19. The electric axial flux machine according to claim 14, wherein, in the case in which the first holding section is integrally formed with the axial flux machine housing, a first axial flux machine housing section is connected to the stator at a first connection point and a second axial flux machine housing section, which forms the first holding section, is connected to the first axial flux machine housing section at a second connection point, and the adjusting element is arranged at the first connection point or second connection point.
